(19) United States
(12) Patent Application Publication
(10) Pub. No.: US 2026/0319118 A1
(43) Pub. Date: Oct. 15, 2026

(54) METHOD AND SYSTEM FOR DETERMINING INTERPOLATED SEISMIC DATA USING INTERPOLATION WINDOWS AND PARALLEL PROCESSING

(71) Applicant: SAUDI ARABIAN OIL COMPANY, Dhahran (SA)

(72) Inventors: Lu Liu, Beijing (CN); Fuhao Qin, Dhahran (SA); Ghada Atef Sindi, Dhahran (SA); Yue Du, Beijing (CN); Hongwei Liu, Dhahran (SA)

(73) Assignees: SAUDI ARABIAN OIL COMPANY, Dhahran (SA); Aramco Far East (Beijing) Business Services Co., Ltd., Beijing (CN)

(21) Appl. No.: 19/484,235

(22) PCT Filed: May 31, 2023
(86) PCT No.: PCT/CN2023/097330

§ 371 Date: Nov. 13, 2025

(51) Int. Cl. G01V 1/36; G01V 1/30

(52) U.S. Cl. CPC G01V 1/36; G01V 1/306; G01V 2210/48

(57) ABSTRACT

A method may include obtaining seismic data regarding a geological region of interest. The method may further include determining, by various parallel processing nodes, various interpolation windows. The method may further include determining, by the parallel processing nodes, various window seismic datasets based on the seismic data and the interpolation windows. The method may further include generating, by the parallel processing nodes, various interpolated window datasets for the interpolation windows using a Fourier transform and the window seismic datasets. A respective interpolated window dataset among the interpolated window datasets may be generated by a respective parallel processing node among the parallel processing nodes. The method may further include generating, by the parallel processing nodes, interpolated seismic data for the geological region of interest using the interpolated window datasets.

### BACKGROUND

Regular and densely sampled data can benefit many data processing approaches, such as data-driven multiple elimination, plane-wave gathers, seismic migration, and amplitude variation with azimuth or offset analyses. Directly acquiring more seismic data may be one way to obtain 3D regularly sampled data. However, acquiring more seismic data may be prohibitively expensive and even impossible in some cases due to complex topography, cable feathering, and editing of bad traces. Therefore, seismic data regularization/interpolation becomes a crucial processing procedure.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method that includes obtaining seismic data regarding a geological region of interest. The method further includes determining, by various parallel processing nodes, various interpolation windows. The method further includes determining, by the parallel processing nodes, various window seismic datasets based on the seismic data and the interpolation windows. The method further includes generating, by the parallel processing nodes, various interpolated window datasets for the interpolation windows using a Fourier transform and the window seismic datasets. A respective interpolated window dataset among the interpolated window datasets is generated by a respective parallel processing node among the parallel processing nodes. The method further includes generating, by the parallel processing nodes, interpolated seismic data for the geological region of interest using the interpolated window datasets.

In general, in one aspect, embodiments relate to a system that includes various parallel processing nodes. The parallel processing nodes determine various interpolation windows. The parallel processing nodes further determine various window seismic datasets based on seismic data for a geological region of interest and the interpolation windows. The parallel processing nodes further generate various interpolated window datasets for the interpolation windows using a Fourier transform and the window seismic datasets. A respective interpolated window dataset among the interpolated window datasets is generated by a respective parallel processing node among the parallel processing nodes. The parallel processing nodes further generate interpolated seismic data for the geological region of interest using the interpolated window datasets.

In light of the structure and functions described above, embodiments disclosed herein may include respective means adapted to carry out various steps and functions defined above in accordance with one or more aspects and any one of the embodiments of one or more aspect described herein.

Other aspects of the disclosure will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1, 2, and 3 show systems in accordance with one or more embodiments.

FIG. 4 shows a flowchart in accordance with one or more embodiments.

FIGS. 5, 6, 7A, 7B, 7C, 8A, and 8B show examples in accordance with one or more embodiments.

FIG. 9 shows a computing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include systems and methods for generating interpolated seismic data using interpolation windows and a parallel processing network. For example, interpolation operations may be performed on seismic data using various parallel processing nodes (e.g., specific parallel processors, multiprocessors, and other nodes within a parallel processing network) to reduce computational runtime, e.g., in a GPU/CPU hybrid platform. In some embodiments, a 5D seismic dataset is split in parallel into multiple 4D datasets according to various keys (e.g., user-defined keys). Next, some embodiments distribute each 4D dataset onto a parallel processing node (e.g., a single GPU) for anti-leakage regularization. Likewise, interpolated data from each 4D dataset may be merged in parallel to produce a final interpolated seismic dataset for the whole coverage area of a geological region. Moreover, seismic data interpolation may be crucial processing procedure because many processing methods require regularly sampled data for a geological region. As such, some embodiments implement anti-leakage Fourier transform interpolation to produce the interpolated seismic data.

Furthermore, “interpolation” and “extrapolation” may be used to refer to multiple types of seismic data prediction processes. In particular, both terms may include interpolation, extrapolation, and/or intrapolation of seismic data, such as to produce interpolated window data, merged data, and/or interpolated seismic data. For illustration, where seismic data is being predicted in a three-dimensional seismic volume for a particular geological region, there may not be a clear distinction whether a process qualifies as an interpolation or an extrapolation. Accordingly, “interpolation” of seismic data and similar data types may refer to any data prediction process that determines seismic data between seismic traces and/or proximate a seismic trace within a desired coverage area.

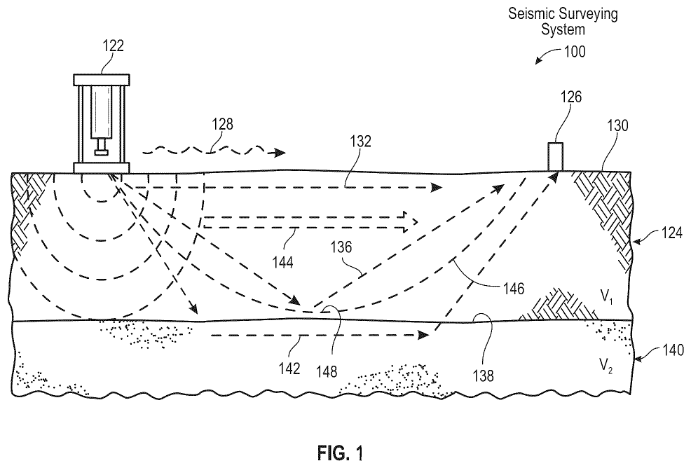

Turning to FIG. 1, FIG. 1 shows a schematic diagram in accordance with one or more embodiments. As shown in FIG. 1, FIG. 1 illustrates a seismic surveying system (100) and various resultant paths of pressure waves (also called seismic waves). The seismic surveying system (100) includes a seismic source (122) that includes functionality for generating pressure waves, such as a reflected wave (136), refracting wave (142), or diving wave (146), through a subsurface layer (124). Pressure waves generated by the seismic source (122) may travel along several paths through a subsurface layer (124) at a velocity V₁ for detection at a number of seismic receivers (126) along the line of profile. Likewise, velocity may refer to multiple velocities types, such as the two types of particle motions resulting from a seismic wave, i.e., velocity of the primary wave (P-wave) and a different velocity of the secondary wave (S-wave) through a particular medium. The seismic source (122) may be a seismic vibrator, such as one that uses a vibroseis technique, an air gun in the case of offshore seismic surveying, explosives, etc. The seismic receivers (126) may include geophones, hydrophones, accelerometers, and other sensing devices. Likewise, seismic receivers (126) may include single component sensors and/or multi-component sensors that measure pressure waves in multiple spatial axes.

As shown in FIG. 1, the seismic source (122) generates an air wave (128) formed by a portion of the emitted seismic energy, which travels above the earth's surface (130) to the seismic receivers (126). The seismic source (122) may also emit surface waves (132), which travel along the earth's surface (130). The speed of the surface waves (132), also called Rayleigh waves or ground roll, may correspond to a velocity typically slower than the velocity of a secondary wave. While the seismic surveying shown in FIG. 1 is a two-dimensional survey along a seismic profile along a longitudinal direction, other embodiments are contemplated, such as three-dimensional surveys.

Furthermore, subsurface layer (124) has a velocity V₁, while subsurface layer (140) has a velocity V₂. In words, different subsurface layers may correspond to different velocity values. In particular, a velocity may refer to the speed that a pressure wave travels through a medium, e.g., diving wave (146) that makes a curvilinear ray path (148) through subsurface layer (124). Velocity may depend on a particular medium's density and elasticity as well as various wave properties, such as the frequency of an emitted pressure wave. Where a velocity differs between two subsurface layers, this seismic impedance mismatch may result in a seismic reflection of a pressure wave. For example, FIG. 1 shows a pressure wave transmitted downwardly from the seismic source (122) to a subsurface interface (138), which becomes a reflected wave (136) transmitted upwardly in response to the seismic reflection. The seismic source (122) may also generate a direct wave (144) that travels directly from the seismic source (122) at the velocity V₁ through the subsurface layer (124) to the seismic receivers (126).

Turning to refracted pressure waves and diving pressure waves, the seismic source (122) may also generate a refracted wave (i.e., refracting wave (142)) that is refracted at the subsurface interface (138) and travels along the subsurface interface (138) for some distance as shown in FIG. 1 until traveling upwardly to the seismic receivers (126). As such, refracted pressure waves (e.g., refracted wave (142)) may be analyzed to map the subsurface layers (124, 140). For example, a refracted wave is a wave that a portion of ray path is along an interface of a reflector as show in refracting wave (142) in FIG. 1 (i.e., refraction exists only when V₂>V₁). On the other hand, a diving wave may be generated where velocities are gradually increasing with depth at a gradient (e.g., diving wave (146)), such that the diving wave may turn back along curvilinear ray path. Likewise, the apex of a diving wave may be consistent with a reflected seismic wave in a common midpoint (CMP) gather.

Furthermore, in analyzing seismic data acquired using the seismic surveying system (100), seismic wave propagation may be approximated using rays. For example, reflected waves (e.g., reflected wave (136)) and diving waves (e.g., diving wave (146)) may be scattered at the subsurface interface (138). In FIG. 1, for example, the diving wave (146) may exhibit a ray path of a wide angle that resembles a reflected wave in order to map the subsurface. Using diving waves, for example, a velocity model for an underlying subsurface may be generated that describes the velocity of different regions in different subsurface layers. An initial velocity model may be generated by modeling the velocity structure of media in the subsurface using an inversion of seismic data, typically referred to as seismic inversion. In seismic inversion, a velocity model is iteratively updated until the velocity model and the seismic data have a minimal amount of mismatch, e.g., the solution of the velocity model converges to a minimum that satisfies a predetermined criterion. For example, the optimization algorithm may be “linearized” and while achieving a “minimum”, there may be no guarantee that it is a global minimum rather than a local minimum. Thus, it may be a simplification commonly adapted in solving inverse problems that works when a respective objective function is convex.

With respect to velocity models, a velocity model may map various subsurface layers based on velocities in different layer sub-regions (e.g., P-wave velocity, S-wave velocity, and various anisotropic effects in the sub-region). For example, a velocity model may be used with P-wave and S-wave arrival times and arrival directions to locate seismic events. Anisotropy effects may correspond to subsurface properties that cause pressure waves to be directionally dependent. Thus, seismic anisotropy may correspond to various parameters in geophysics that refers to variations of wave velocities based on direction of propagation. One or more anisotropic algorithms may be performed to determine anisotropic effects, such as an anisotropic ray-tracing location algorithm or algorithms that use deviated-well sonic logs, vertical seismic profiles (VSPs), and core measurements. Likewise, a velocity model may include various velocity boundaries that define regions where rock types changes, such as interfaces between different subsurface layers. In some embodiments, a velocity model is updated using one or more tomographic updates to adjust the velocity boundaries in the velocity model.

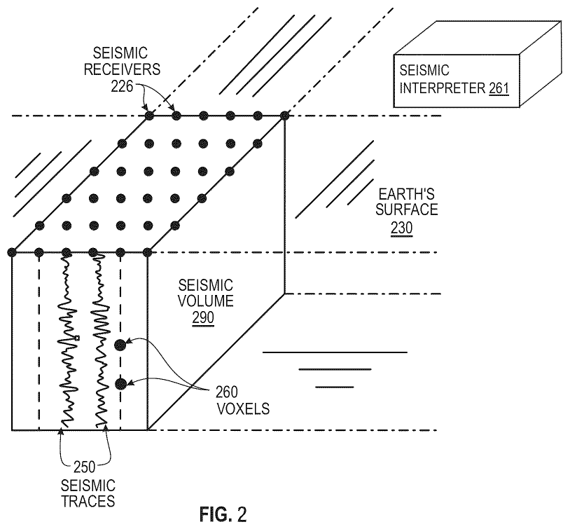

Turning to FIG. 2, FIG. 2 illustrates a system in accordance with one or more embodiments. As shown in FIG. 2, a seismic volume (290) is illustrated that includes various seismic traces (e.g., seismic traces (250)) acquired by various seismic receivers (e.g., seismic receivers (226)) disposed on the earth's surface (230). More specifically, a seismic volume (290) may be a cubic dataset of seismic traces for a 2D line, and a 5D dataset for a 3D survey. In particular, seismic data may have up to four spatial dimensions, one temporal dimension (i.e., related to the actual measurements stored in the traces), and possibly another temporal dimension related to time-lapse seismic surveys. Individual cubic cells within the seismic volume (290) may be referred to as voxels or volumetric pixels (e.g., voxels (260)). In particular, different portions of a seismic trace may correspond to various depth points within a volume of earth. To generate the seismic volume (290), a three-dimensional array of seismic receivers (226) are disposed along the earth's surface (230) and acquire seismic data in response to various pressure waves emitted by seismic sources. Within the voxels (260), statistics may be calculated on first break data that is assigned to a particular voxel to determine multimodal distributions of wave traveltimes and derive traveltime estimates (e.g., according to mean, median, mode, standard deviation, kurtosis, and other suitable statistical accuracy analytical measures) related to azimuthal sectors. First break data may describe the onset arrival of refracted waves or diving waves at the seismic receivers (226) as produced by a particular seismic source signal generation.

Seismic data may refer to raw time domain data acquired from a seismic survey (e.g., acquired seismic data may result in the seismic volume (290)). However, seismic data may also refer to data acquired over different periods of time, such as in cases where seismic surveys are repeated to obtain time-lapse data. Seismic data may also refer to various seismic attributes derived in response to processing acquired seismic data. Furthermore, in some contexts, seismic data may also refer to depth data or image data. Likewise, seismic data may also refer to processed data, e.g., using a seismic inversion operation, to generate a velocity model of a subterranean formation, or a migrated seismic image of a rock formation within the earth's surface. Seismic data may also be pre-processed data, e.g., arranging time domain data within a two-dimensional shot gather.

Furthermore, seismic data may include various spatial coordinates, such as (x,y) coordinates for individual shots and (x,y) coordinates for individual receivers. As such, seismic data may be grouped into common shot or common receiver gathers. In some embodiments, seismic data is grouped based on a common domain, such as common midpoint (i.e., Xmidpoint=(Xshot+Xrec)/2, where Xshot corresponds to a position of a shot point and Xrec corresponds to a position of a seismic receiver) and common offset (i.e., Xoffset=Xshot−Xrec).

In some embodiments, seismic data is processed to generate one or more seismic images. For example, seismic imaging may be performed using a process called migration. In some embodiments, migration may transform pre-processed shot gathers from a data domain to an image domain that corresponds to depth data. In the data domain, seismic events in a shot gather may represent seismic events in the subsurface that were recorded in a field survey. In the image domain, seismic events in a migrated shot gather may represent geological interfaces in the subsurface. Likewise, various types of migration algorithms may be used in seismic imaging. For example, one type of migration algorithm corresponds to reverse time migration. In reverse time migration, seismic gathers may be analyzed by: 1) forward modelling of a seismic wavefield via mathematical modelling starting with a synthetic seismic source wavelet and a velocity model; 2) backward propagating the seismic data via mathematical modelling using the same velocity model; 3) cross-correlating the seismic wavefield based on the results of forward modeling and backward propagating; and 4) applying an imaging condition during the cross-correlation to generate a seismic image at each time step. The imaging condition may determine how to form an actual image by estimating cross-correlation between the source wavefield with the receiver wavefield under the basic assumption that the source wavefield represents the down-going wavefield and the receiver wave-field the up-going wave-field.

In Kirchhoff and other migration methods, for example, the imaging condition may include a summation of contributions resulting from the input data traces after the traces have been spread along portions of various isochrones (e.g., using principles of constructive and destructive interference to form the image). For example, Kirchhoff migration function may be based on an integral form of a wave equation that corresponds to pressure wave displacement and a pressure wave velocity as function of three-dimensional space and time. As such, 3D prestack Kirchhoff depth migration may be characterized as the summation of various reflection amplitudes along diffraction traveltime curves to obtain the output seismic images. As such, Kirchhoff algorithms may preprocessing input seismic traces, determine traveltime tables for pressure waves using ray-tracing and a velocity model, and migrate these seismic traces. Besides Kirchhoff algorithms, other migration functions are also contemplated such as finite-difference migration, frequency-space migration, and frequency-wavenumber migration, and Stolt migration.

Furthermore, seismic data processing may include various seismic data functions that are performed using various process parameters and combinations of process parameter values. For example, a seismic interpreter may test different parameter values to obtain a desired result for further seismic processing. Depending on the seismic data processing algorithm, a result may be evaluated using different types of seismic data, such as directly on processed gathers, normal moveout corrected stacks of those gathers, or on migrated stacks using a migration function. Where structural information of the subsurface is being analyzed, migrated stacks of data may be used to evaluate seismic noise that may overlay various geological boundaries in the subsurface, such as surface multiples (e.g., strong secondary reflections that are detected by seismic receivers). As such, migrated images may be used to determine impact of noise removal processes, while the same noise removal processes may operate on gather data.

While seismic traces with zero offset are generally illustrated in FIG. 2, seismic traces may be stacked, migrated and/or used to generate an attribute volume derived from the underlying seismic traces. For example, an attribute volume may be a dataset where the seismic volume undergoes one or more processing techniques, such as amplitude-versus-offset (AVO) processing. In AVO processing, seismic data may be classified based on reflected amplitude variations due to the presence of hydrocarbon accumulations in a subsurface formation. With an AVO approach, seismic attributes of a subsurface interface may be determined from the dependence of the detected amplitude of seismic reflections on the angle of incidence of the seismic energy. This AVO processing may determine both a normal incidence coefficient of a seismic reflection, and/or a gradient component of the seismic reflection. Likewise, seismic data may be processed according to a pressure wave's apex. In particular, the apex may serve as a data gather point to sort first break picks for seismic data records or traces into offset bins based on the survey dimensional data (e.g., the x-y locations of the seismic receivers (226) on the earth surface (230)). The bins may include different numbers of traces and/or different coordinate dimensions.

Additionally, seismic imaging may be near the end of a seismic data workflow before an analysis by a seismic interpreter. The seismic interpreter may subsequently derive understanding of the subsurface geology from one or more final migrated images. In order to confirm whether a particular seismic data workflow accurately models the subsurface, a normal moveout (NMO) stack may be generated that includes various NMO gathers with amplitudes sampled from a common midpoint (CMP). In particular, a NMO correction may be a seismic imaging approximation based on calculating reflection traveltimes.

In some embodiments, one or more regularization processes may be performed on an acquired seismic dataset to produce regularized data. In particular, acquired seismic data may include irregular data that lacks a periodic spatial distribution or periodic interval of seismic traces throughout a coverage area for several reasons, including complex topography, cable feathering, editing of bad traces, and high acquisition cost. For example, three-dimensional (3D) land surveys, 3D ocean bottom cable (OBC) surveys, and 3D ocean bottom node (OBN) surveys may acquire irregular during the seismic acquisition process due to limitations of surveying techniques and/or complex geological topography. As such, irregular data may experience poor results from various seismic data processes, such as seismic plane-wave processing, surface-related multiple elimination techniques, and migration algorithms. However, regularized and densely sampled seismic data may be required for many seismic data processing approaches, such as plane-wave processing, surface-related multiple elimination, etc.

Furthermore, regularization processes may perform data reconstruction, interpolation, and/or extrapolation on pre-stack seismic data to fill gaps in acquisition coverage and azimuth distributions, and improving offsets. In particular, regularization processes may increase the number of seismic traces within an acquisition area, e.g., to increase fold or reduce bin sizes. For example, regularization processes may increase the number of seismic source locations and/or seismic receiver locations based on acquired seismic data. Regularized data may also be used to produce a regular grid of seismic data with a predetermined periodic interval (e.g., where the interval matches a desired number of seismic receiver locations and/or seismic source locations) for disposing various bin centers within the regular grid. Accordingly, regularized data may include interpolated seismic traces with a regular grid, interpolated source lines, and/or interpolated receiver lines. By mixing acquired seismic data and interpolated seismic data, various holes in a seismic survey may be eliminated in the offset and azimuth directions while amplitude variations may also be preserved with respect to offsets and azimuths (e.g., for AVO processing and/or AVAz processing). Examples of regularization processes include sinc interpolation, high-resolution Radon transform interpolation, artificial neural network applications, etc.

In some embodiments, a regularization process is performed using one or more Fourier transforms. For example, a multi-dimensional Fourier transform may be used to transform irregular seismic data with four spatial dimensions into interpolated seismic data regularized for a regular grid. A multi-dimensional Fourier transform may be expressed using the following equation:

$$FT ( {K}_{x} , {K}_{y} , {K}_{{O}_{Σ}} , {K}_{O} \text{?} ) = {\sum }_{n = 1}^{N} {w}_{n} {d}_{n} {e}^{- 2} \text{?} {K}_{Σ} {e}^{- 2} \text{?} K \text{?} {e}^{- 2 π {iO}_{x} \text{?}} {K}_{{O}_{x}} {e}^{- 2 π {iO}_{{x}_{n}} {K}_{{O}_{y}}}$$

$$\text{?} \text{indicates text missing or illegible when filed}$$

where dₙ corresponds to acquired seismic traces for one frequency slice, Kₓ, K_{y}, K_{Ox}, and K_{Oy} correspond to various wavenumbers for different spatial dimensions, xₙ, yₙ, Oₓₙ and O_{yn} correspond to seismic coordinates based on midpoint-x, midpoint-y, offset-x, and offset-y, respectively, and wₙ corresponds to a weighting function . . . . For a Fourier summation of regularized data, Fourier coefficients may be solved iteratively in Equation 1 using different sequences of solving operations. On the other hand, the frequency spectrum may be computed directly (i.e., rather than solving iteratively) using a Fast Fourier Transform (FFT) of Equation 1 due to the spatial interval being constant. For example, Fourier coefficients in a Fourier transform may be solved recursively, beginning with a Fourier coefficient with the maximum seismic energy and proceeding down to the Fourier coefficient with the minimum seismic energy. An inverse irregular Fourier transform may be used to remove a particular Fourier coefficient from the input seismic data to produce seismic data in the frequency domain. After all Fourier coefficients from the input seismic data during an iterative process, the final updated input seismic data on the irregular grid may converge to zero. As such, the reconstructed regularized data may fit the acquired seismic data and meet one or more interpolation criteria. Once a forward Fourier transform has been performed on the input seismic data, a reverse irregular Fourier transform may be used to map the interpolated seismic traces to any seismic receiver locations.

Furthermore, Equation 1 above is one example of using Fourier transforms for performing seismic data regularization. Where four spatial dimensions are independent with each respect to other, a function based on Equation 1 may be applied to the seismic data, such as using vector midpoints and vector offset. However, other embodiments are also contemplated such as data regularization functions based on shot x-y coordination, receiver x-y coordination, a function based on source x-y coordination, azimuth and offset, a function based on receiver x-y coordination, azimuth, and offset, etc.

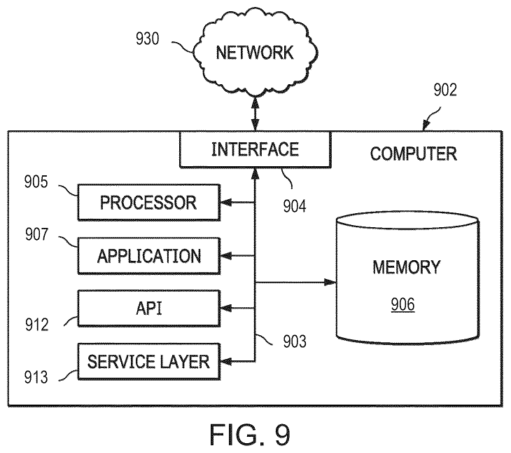

Turning to the seismic interpreter (261), a seismic interpreter (261) (also called a “seismic processing system”) may include hardware and/or software with functionality for storing the seismic volume (290), well logs, core sample data, and other data for seismic data processing, well data processing, and other data processes accordingly. In some embodiments, the seismic interpreter (261) may include a computer system that is similar to the computer (902) described below with regard to FIG. 9 and the accompanying description. While a seismic interpreter may refer to one or more computer systems that are used for performing seismic data processing, the seismic interpreter may also refer to a human analyst performing seismic data processing in connection with a computer. While the seismic interpreter (261) is shown at a seismic surveying site, in some embodiments, the seismic interpreter (261) may be remote from a seismic surveying site.

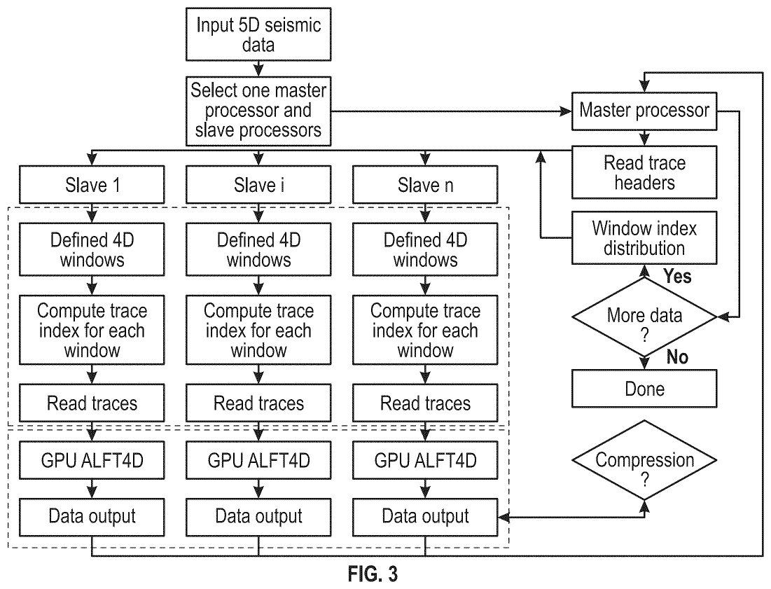

Turning to FIG. 3, FIG. 3 shows a schematic diagram in accordance with one or more embodiments. As shown in FIG. 3 among these total parallel processors, one processor may be selected as a master processor. Other processors (e.g., 8, 4 or 2 processors) may operate as slave processors. In particular, the master processor may pass a window index to a slave processor. Afterwards, a slave processor may define the window boundaries and then read the associated seismic traces from the input data according to the window index received from the master processor. Therefore, such data reading may be performed in parallel. Next, various slave processors may pass the traces within the specific window to one GPU for data regularization. Likewise, each GPU may transfer the regularized data back to a seismic interpreter or central processing unit coupled to the slave processors. Thus, slave processors may write regularized data onto disk, or compress the data first and then write the regularized data to the disk. In some embodiments, only seismic header information is passed from the master processor to various slave processors. The slave processors may read the seismic data directly from a seismic data repository.

Keeping with FIG. 3, a GPU may transfer regularized data back to a seismic interpreter or a central processing unit (CPU) coupled to the slave processors. Likewise, slave processors may write regularized data onto disk, or compress the regularized data first and then write to disk. As the procedure may include an interpolation process and a merging process, a parallel processing network may perform a first job for splitting the input data into many small-window 4D data and then regularize them; and a second job that merges the regularized 4D data into 5D regularized data in parallel according to the user-defined sorting headers.

Furthermore, a GPU may include various hardware, such as a set of multiprocessors, where a respective multiprocessor may include multiple individual processors (which may be referred to as “cores”), and one or more shared memories. As such, a GPU may perform a specific seismic operation that may be referred to as a “kernel” that is performed using multiple hardware threads operating in parallel. For example, a GPU may execute the kernel using one or more thread blocks, where a thread block includes a group of single instruction, multiple data (SIMD) threads. As such, multiple thread blocks may be executed by a single multiprocessor concurrently on a GPU. Thus, GPUs may include functionality for accelerating image generation, which may also make GPUs suitable hardware for executing parallel processing in order to perform seismic data operations that include complex computations. A processor may be a parallel processor and similar to the computer processor (905) described below in FIG. 9 and the accompanying description. In particular, the term “parallel processor” may refer to multiprocessors, individual processors, and computer processors that operate in parallel in a processing operation.

Keeping with GPUs, a GPU may include different types of memory hardware, such as register memory, shared memory, device memory, constant memory, texture memory, etc. For example, register memory and shared memory may be disposed on an actual GPU chip, while other types of memory may be separate components in the GPU. In particular, register memory may only be accessible to the hardware thread that wrote its memory values, which may only last throughout the respective thread's lifetime. On the other hand, shared memory may be accessible to all hardware threads within a thread block and shared memory values may exist for the duration of the thread block (e.g., shared memory enables hardware threads to communicate and share data between one another). Device memory may be global memory that is accessible to any hardware threads within a GPU's application as well as devices outside the GPU, such as a seismic interpreter or seismic processing system. Device memory may be allocated by a host for example, and may survive until the host deallocates the memory. Constant memory may be a read-only memory device that provides memory values that do not change over the course of a kernel execution (e.g., constant memory may provide data faster than device memory and thus reduce memory bandwidth). Texture memory may be another read-only memory device that is similar to constant memory, where the memory reads in texture memory may be limited to physically adjacent hardware threads, e.g., those hardware threads in a warp.

In some embodiments, multiple GPUs, a central processing unit, and/or one or more seismic interpreters may communicate with each other using a peer-to-peer (P2P) communication protocol. For example, two GPUs may be attached to the same PCIe bus in a seismic interpreter and communicate directly with each other. Thus, over a P2P communication protocol, a component in a seismic interpreter may access a different memory in another GPU or a central processing unit (CPU). In some embodiments, for example, a master processor may not store locally the window data or merged window data, but may simply access the device memory or the texture memory in a GPU that stores the respective data. Likewise, the P2P communication protocol may also enable direct memory transfers between system components.

While FIGS. 1, 2, and 3 show various configurations of components, other configurations may be used without departing from the scope of the disclosure. For example, various components in FIGS. 1, 2, and 3 may be combined to create a single component. As another example, the functionality performed by a single component may be performed by two or more components.

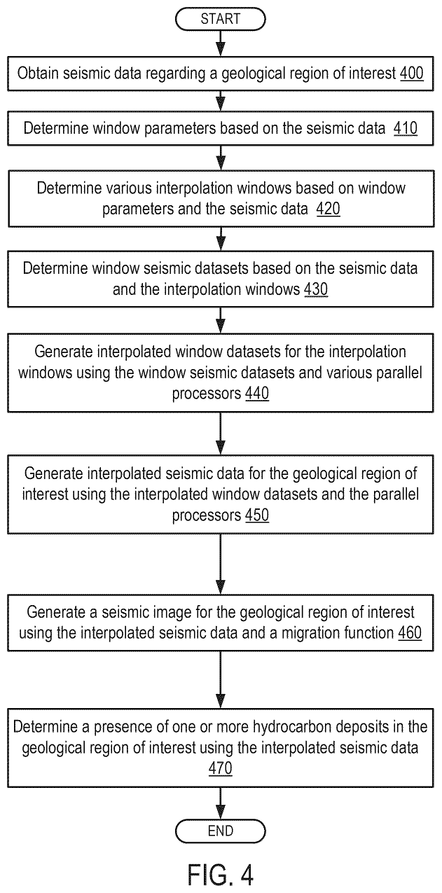

Turning to FIG. 4, FIG. 4 shows a flowchart in accordance with one or more embodiments. Specifically, FIG. 4 describes a general method for generating interpolated seismic data using parallel processing nodes. One or more blocks in FIG. 4 may be performed by one or more components (e.g., seismic interpreter (261)) as described in FIGS. 1 2, and 3. While the various blocks in FIG. 4 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 400, seismic data are obtained regarding a geological region of interest in accordance with one or more embodiments. A geological region of interest may be a portion of a geological area or volume that includes one or more formations of interest desired or selected for analysis, e.g., for determining location of hydrocarbons or reservoir development purposes. The seismic data may be similar to the seismic data described above in FIGS. 1, 2, and 3 and the accompanying description.

In Block 410, various window parameters are determined based on seismic data in accordance with one or more embodiments. In some embodiments, a seismic interpreter, a master processor, and/or a parallel processing node may determine various window parameters for different interpolation windows. For example, the window parameters may correspond to different spatial dimensions for sorting different seismic traces among the interpolation windows. In some embodiments, the window parameters are used with a Fourier transform to generate interpolated seismic data. Additionally, window parameters are determined by scanning trace headers within seismic data, such as to transform global trace coordinates into grid numbers. Thus, window parameter according to various input parameters associated with the seismic data.

Furthermore, an interpolation window may be determined by various window parameters that represent spatial boundaries defining the window. In some embodiments, window parameters specify one or more tapering ranges and one or more overlapping ranges of adjacent interpolation windows in three dimensions. For example, an interpolation window may include one or more overlapping zones (e.g., based on an overlapping range) and one or more tapering zones (e.g., based on a tapering range). In an overlapping zone, seismic traces in the zone may be used by adjacent interpolation windows to produce interpolated window data. This interpolated window data from one interpolation window may then be combined with similar interpolated window data from another interpolation window for the same overlapping zone by a merging process. On the other hand, seismic traces in a tapering zone may only be involved in determining interpolated window data for regions outside the tapering zone. Thus, an interpolation window may not output any interpolated window data for a tapering zone.

In some embodiments, window parameters are based on one or more user selections from an input device. For example, a splitting function for sorting seismic data among various interpolation windows may correspond to various spatial keys that are selected by a user. In particular, a user-defined primary key represents the slowest spatial dimension for the regularized seismic data, and may be used to produce a 4D small-window dataset. For 4D interpolation, three spatial dimensions and one time dimension are being used in the data regularization process, so a loop is used over the primary key. Other spatial keys (e.g., Keyₓ, Key_{y}, Key_{z}) may be selected from slow to fast spatial dimension for interpolating window data. In other words, the spatial dimensions for 5D regularized data are primary key, Keyₓ, Key_{y}, Key_{z} from slow to fast dimension.

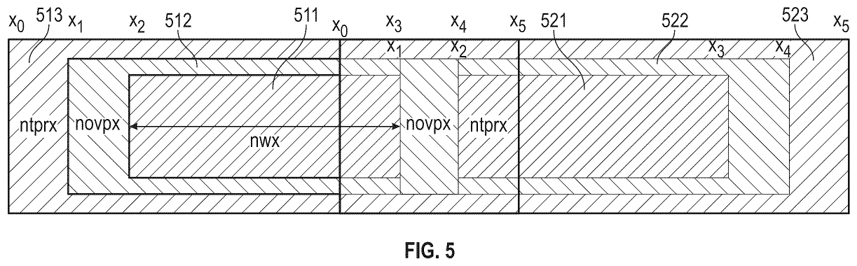

Turning to FIG. 5, FIG. 5 shows an example of two interpolation windows in two spatial dimensions in accordance with one or more embodiments. In FIG. 5, an interpolation window A and an interpolation window B are adjacent windows. For example, interpolated window A includes a non-overlapping zone A (511), an overlapping zone B (512) that overlaps with overlapping zone E (522) for interpolation window B. The interpolated window A also includes a tapering zone C (513) for computation purposes. Likewise, interpolation window B also includes a non-overlapping zone D (521), the overlapping zone E (522), and a tapering zone F (523). As such, interpolation window A and interpolation window B are defined according to various spatial parameters, i.e., x₀, x₁, x₂, x₃, x₄, and x₅.

Returning to FIG. 4, in Block 420, various interpolation windows are determined based on window parameters and seismic data in accordance with one or more embodiments. For example, a parallel processing network may be used to determine different interpolation windows for different parallel processing nodes using the window parameters. The parallel processing network may also include various parallel processing nodes, such as GPUs or a portion of the processors on a GPU, a central processing unit, a seismic interpreter, slave processors, and/or a master processor.

In some embodiments, a multi-level parallel architecture may be implemented for seismic data interpolation. Multi-level may refer to computing based on Message Passing Interface (MPI) protocols, Multi-GPUs parallel computing, and GPU fine-grained parallel computation. For example, an MPI protocol may be a communication protocol for programming parallel processing nodes. MPI protocols may include point-to-point protocols and collective communication protocols. The MPI standard may define the syntax and semantics of various library routines that may be used to implement portable message-passing programs within a parallel processing network.

In some embodiments, a parallel processing network uses a master-slave network architecture. The parallel processing network may have one processor designated as a master processor or a seismic interpreter, and other nodes as slave processors. The master processor may read the trace headers from the seismic data and subsequently broadcasts the headers to various slave nodes. The slave nodes may determine the window parameters, such as spatial boundaries, for each interpolation window. Afterwards, the slave nodes may select the trace indices for each interpolation window. Additionally, some interpolation windows may be removed with trace numbers that are less than a predetermined criterion, such as a threshold. A master processor may also assign various interpolation tasks for each slave process (e.g., a slave process may include generating respective interpolated window data at the respective slave processor). As such, the master processor may inform each slave processor of the window index for producing interpolated window data. A slave node may be associated with one or more GPUs.

Returning to FIG. 4, in Block 430, window seismic datasets are determined based on seismic data and interpolation windows in accordance with one or more embodiments. In some embodiments, a seismic interpreter or a master processor performs pre-processing and sorting on the seismic data to determine which seismic traces correspond to which interpolation windows. On the other hand, seismic data splitting may also be performed by other components within the parallel processing network, such as individual slave nodes. In some embodiments, interpolation windows may be determined by going through various trace headers of the seismic data and then defining window numbers and window boundaries as specified by the window parameters. The seismic traces may be extracted in parallel for each interpolation window. Splitting operations may be performed on the fly, such that interpolated results or compressed interpolated results may only be written on the disk (i.e., stored outside of a memory device).

In Block 440, various interpolated window datasets are generated for various interpolation windows using various window seismic datasets and various parallel processors in accordance with one or more embodiments. For example, various interpolation processes may be performed using a subset of seismic data associated with a particular interpolation window. More specifically, interpolation processes may include linear interpolation, polynomial interpolation, and spline interpolation (such as cubic spline interpolation). Polynomial interpolation may be based on Lagrange polynomials or Newton polynomials. Spline interpolation may be a form of interpolation that uses a piecewise polynomial called a spline as the interpolant. Thus, instead of fitting a single, high-degree polynomial to various seismic datapoints at once, spline interpolation may fit low-degree polynomials to small subsets of the seismic data.

Furthermore, interpolating window data may be generated by interpolating window data between different seismic frames within a seismic survey. In other words, a parallel processing node may “guess” or “project” how various in-between frames (i.e., keyframes) may behave based pressure waves and the underlying geology. Using spline interpolation, for example, a smooth transition may occur from one seismic keyframe to another seismic keyframe. Keyframes may also be used with linear interpolation. With linear interpolation, a straight transition may occur from seismic keyframe to seismic keyframe, with abrupt changes as defined by the seismic keyframes themselves. Keyframes may also be used in step interpolation, where this interpolation process may “jump” from a seismic keyframe value at a given survey time.

In some embodiments, a Fourier transform is used to determine window data for different interpolation windows. For example, a Fourier transform, such as Equation 1 above, may be used to estimate the spatial frequency content on an irregularly sampled grid by selecting the most energetic Fourier coefficient. For example, seismic traces associated with a particular interpolation window may be input to the Fourier transform to produce regularized seismic data for a spatial dimension x and using a predetermined frequency and wavenumber. A similar procedure may be used for higher spatial dimensions. However, the picked seismic energy may result from aliasing events if the input seismic data are too sparse. To address aliasing, a weighting function may be used that averages the frequency spectrum along radial lines and applies weighting to various data points prior to event selection. Weights may be used to assist event selection rather than being applied to actual values of seismic data. Thus, window seismic data may be reconstructed on any desired grid using Fourier transforms and the seismic frequency data.

In some embodiments, after interpolated window data is generated in a frequency domain, the interpolated window data is transformed back to a time domain. For example, an inverse Fourier transform may be used accordingly.

In some embodiments, interpolated window data produced for an interpolation window may be compressed, e.g., for writing to a hard disk. Once window seismic data is compressed, one or more decompression procedures and functions may be performed to generate interpolated seismic data in the following steps. Compression techniques and functions may allow the interpolated result from each interpolation window to be much smaller than the original seismic data for merging purposes.

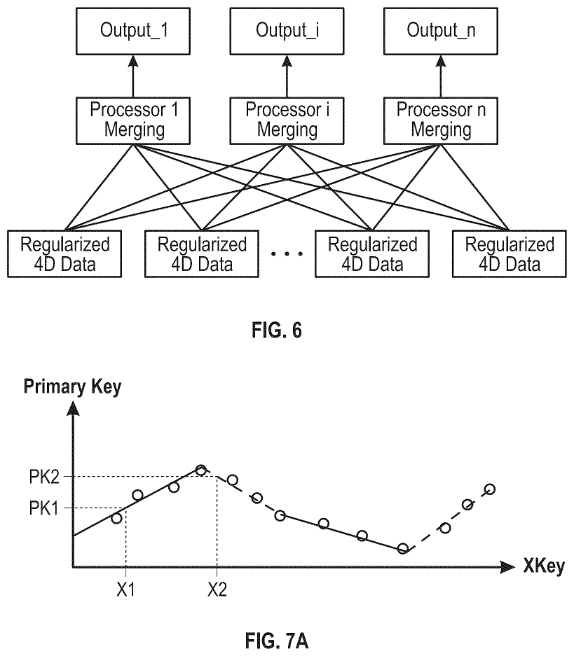

In Block 450, interpolated seismic data are generated for a geological region of interest using various interpolated window datasets and various parallel processors in accordance with one or more embodiments. Once interpolated window data are generated for various interpolation windows, the interpolated window data may be merged into a single seismic volume or seismic dataset using parallel processing. For example, various parallel processing nodes may read interpolated traces from the interpolated window datasets according to a particular index and merger process. The parallel processing nodes may subsequently write merged data to a final interpolated seismic dataset after merging all of the interpolated traces. For example, the merging process may be performed using one or more MPI protocols. In some embodiments, data merging includes decompressing the interpolated window datasets and combining the output to form a whole 5D interpolated seismic dataset. An example of a parallel merging process for interpolated data is shown in FIG. 6.

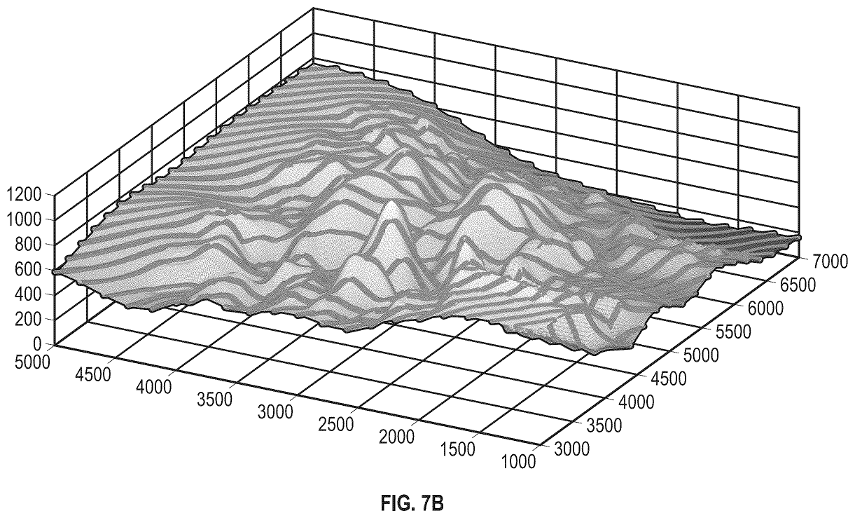

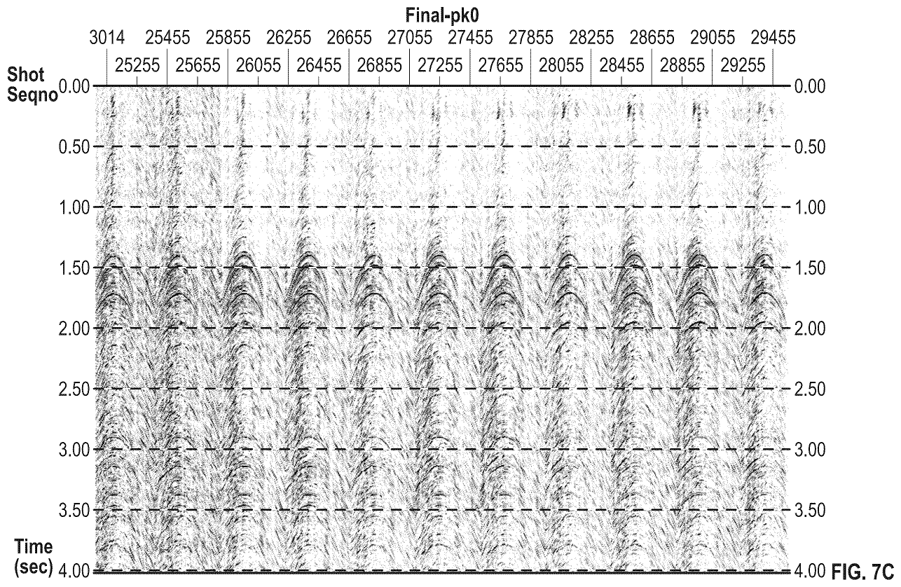

Turning to FIG. 7A, FIG. 7A illustrates an interpolation process in accordance with one or more embodiments. After interpolated window data is generated, associated headers may be determined for the data. For example, header interpolation may include several processes. First, a primary key may have a linear relationship with the Keyₓ, which may be the slowest spatial dimension for regularization, i.e. P_{key}=SCALE*Keyₓ+C. For each interpolation window, values for SCALE and C may be estimated by least square fitting. Next, the primary key's value may be assigned according to regularized coordination of Keyₓ and the coefficients SCALE and C. Thus, FIG. 7A illustrates primary key interpolation using linear regression.

Furthermore, B-spline interpolation may be used to determine headers for the interpolated window data. The headers may include receiver elevation, source buried depth, statics, etc. As such, header values may be functions of (Keyₓ, Key_{y}, Key_{z}). Moreover, a B-spline function can ensure that the value at a known receiver or source position is unchanged in the interpolated seismic data. FIG. 7B shows an elevation interpolation using B-spline interpolation, where solid lines denote known elevation values, and the curved segmented surface is the interpolated result using this merging process. Likewise, FIG. 7C shows a partial interpolated result for a seismic dataset illustrating associated regularized seismic data.

In Block 460, a seismic image is generated for a geological region of interest using interpolated seismic data in accordance with one or more embodiments. In some embodiments, the seismic image corresponds to an output image volume based on interpolated seismic data merged from various parallel processing nodes. For example, a set of interpolated seismic data gathers may be summed or stacked to produce a final seismic image. In some embodiments, the seismic image provides a spatial and depth illustration of a subsurface formation for various practical applications, such as predicting hydrocarbon deposits, predicting wellbore paths for geosteering, etc. After all input traces have been migrated, the output image volume may then be post-processed and saved on a hard disk. In some embodiments, a velocity model is updated for a geological region of interest based on interpolated seismic data. For example, interpolated seismic data may be used to determine a tomographic update for the velocity model. Using the tomographic update, the velocity model may be updated accordingly.

In Block 470, a presence of one or more hydrocarbon deposits are determined in a geological region of interest using a seismic image in accordance with one or more embodiments.

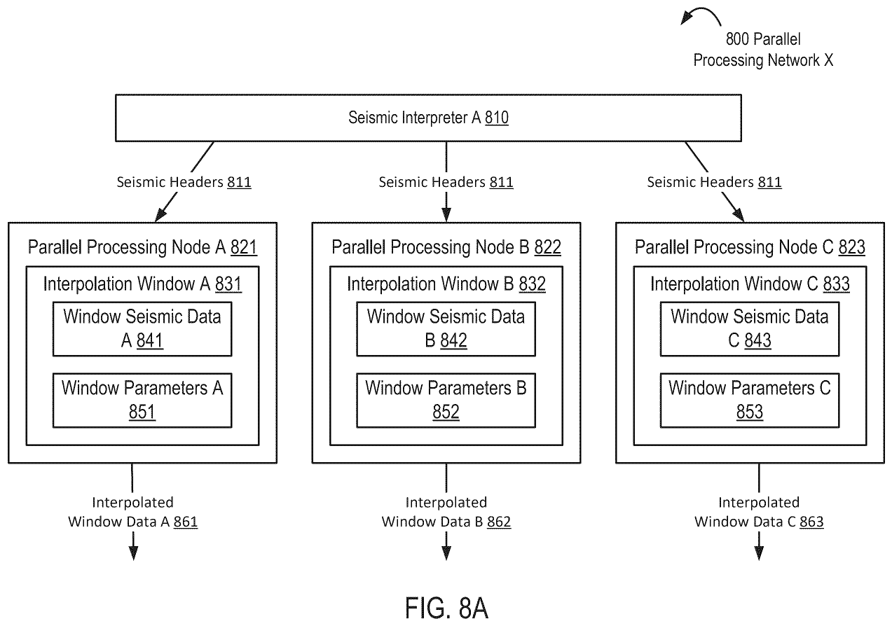

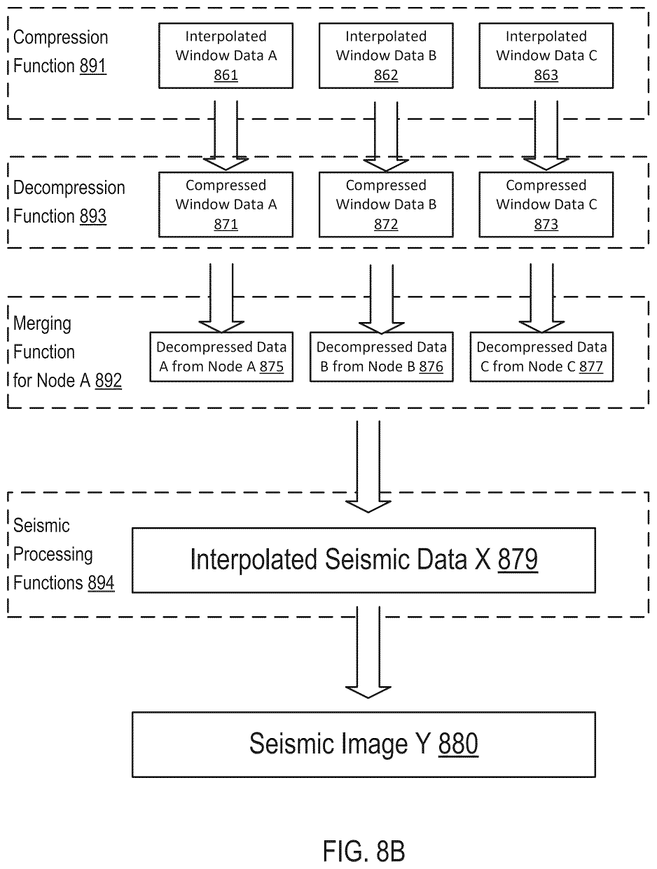

Turning to FIGS. 8A-8B, FIG. 8A-8B provide an example of generating interpolated seismic data using a parallel processing network in accordance with one or more embodiments. The following example is for explanatory purposes only and not intended to limit the scope of the disclosed technology.

In FIG. 8A, a parallel processing network X (800) includes a seismic interpreter A (810) and various parallel processing nodes, i.e., parallel processing node A (821), parallel processing node B (822), and parallel processing node C (823). The seismic interpreter A (810) may be a seismic interpreter, a central processing unit, or another parallel processing node in the parallel processing network X (800). As shown in FIG. 8A, the seismic interpreter A (810) obtains seismic headers (811) from seismic data of a seismic data source (not shown) and transmits the seismic headers (811) to each of the parallel processing nodes (821, 822, 823). Using window parameters (i.e., window parameters A (851), window parameters B (852), window parameters C (853)) and the seismic headers (811), the parallel processing nodes (821, 822, 823) determine multiple interpolation windows, i.e., interpolation window A (831), interpolation window B (832), and interpolation window C (833). As such, the parallel processing node A (821) reads a portion of the seismic data to produce window seismic data A (841) for the interpolation window A (831). Likewise, the parallel processing node B (822) and parallel processing node C (823) read portions of the seismic data to produce window seismic data B (842) for the interpolation window B (832) and window seismic data C (843) for the interpolation window C (833), respectively. Using parallel computing, the parallel processing node A (821) generate interpolated window data A (861) in parallel with the parallel processing node B (822) generating interpolated window data B (862) and the parallel processing node C (823) generating interpolated window data C (863).

In some embodiments, for example, a master processor reads the seismic headers and transmit the headers to all slave processors, then passes one window index to one slave processor, respectively. Each slave processor may then define the window boundaries and then read the associated traces from the input data according to the window index it receives from the master. Therefore, this seismic data reading may be performed in parallel. Then, a respective slave processor may pass the seismic traces within the specific window to one GPU for data regularization. Seismic data may not transmitted directly over the parallel processing network because the seismic data, because the seismic data be analyzed may be very huge, (e.g., in multiple terabytes (TB)), and thus the entire seismic dataset cannot be stored in the memory within the network.

Turning to FIG. 8B, the parallel processing network X (800) performs various functions (e.g., compression function (891), merging function (892), decompression function (893), and seismic processing functions (894)) and processes to the interpolated window data (861, 862, 863) to generate a final seismic image Y (890). These functions may be performed in parallel by the parallel processing nodes (821, 822, 823). Likewise, in some embodiments, the functions may be performed by the seismic interpreter A (810), a seismic interpreter (not shown), or another parallel processing node that is not shown in FIG. 8A. Moreover, various functions and tasks may be assigned to different parallel processing nodes, such as interpolation tasks for generating interpolated window data, splitting seismic data into subsets for window seismic data, compressing interpolated data, and/or decompressing interpolated data.

Keeping with FIG. 8B, a compression function is applied to the interpolated window data A (861), interpolated window data B (862), and interpolated window data C (863) to produce compressed window data A (871), compressed window data B (872), and compressed window data C (873), respectively. If a user activates a compression function, then the interpolated data may be compressed first, then written to hard disk. After that, each slave processor may read the compressed interpolated data (i.e., compressed window data A (871), compressed window data B (872), compressed window data C (873)), then use the decompression function (893) to produce decompressed data A (875) from node A, decompressed data B (876) from node B, and decompressed data C (877) from node C. If a user does not activate a compression function, then neither compression nor decompression may be needed for interpolation.

Afterwards, the decompressed window data (875, 876, 877) is used as inputs to a merging function (892) that is performed by parallel processing node A (821). The merging function (892) outputs interpolated seismic data X (879) from the various parallel processing nodes. The parallel processing network X (800) next applies seismic processing functions (894) to the interpolated seismic data X (879), such as noise removal techniques, surface multiple eliminators, migration functions, etc. As such, a seismic image Y (880) is generated through seismic processing the interpolated seismic data X (879).

### Computer System

Embodiments may be implemented on a computer system. FIG. 9 is a block diagram of a computer system used to provide computational functionalities associated with described algorithms, methods, functions, processes, flows, and procedures as described in the instant disclosure, according to an implementation. The illustrated computer (902) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (902) may include a computer that includes an input device, such as a keypad, keyboard, touch screen, or other device that can accept user information, and an output device that conveys information associated with the operation of the computer (902), including digital data, visual, or audio information (or a combination of information), or a GUI.

The computer (902) can serve in a role as a client, network component, a server, a database or other persistency, or any other component (or a combination of roles) of a computer system for performing the subject matter described in the instant disclosure. The illustrated computer (902) is coupled with a network (930) or cloud. In some implementations, one or more components of the computer (902) may be configured to operate within environments, including cloud-computing-based, local, global, or other environment (or a combination of environments).

At a high level, the computer (902) is an electronic computing device operable to receive, transmit, process, store, or manage data and information associated with the described subject matter. According to some implementations, the computer (902) may also include or be coupled with an application server, e-mail server, web server, caching server, streaming data server, business intelligence (BI) server, or other server (or a combination of servers).

The computer (902) can receive requests over network (930) or cloud from a client application (for example, executing on another computer (902)) and responding to the received requests by processing the said requests in an appropriate software application. In addition, requests may also be sent to the computer (902) from internal users (for example, from a command console or by other appropriate access method), external or third-parties, other automated applications, as well as any other appropriate entities, individuals, systems, or computers.

Each of the components of the computer (902) can communicate using a system bus (903). In some implementations, any or all of the components of the computer (902), both hardware or software (or a combination of hardware and software), may interface with each other or the interface (904) (or a combination of both) over the system bus (903) using an application programming interface (API) (912) or a service layer (913) (or a combination of the API (912) and service layer (913). The API (912) may include specifications for routines, data structures, and object classes. The API (912) may be either computer-language independent or dependent and refer to a complete interface, a single function, or even a set of APIs. The service layer (913) provides software services to the computer (902) or other components (whether or not illustrated) that are coupled to the computer (902). The functionality of the computer (902) may be accessible for all service consumers using this service layer. Software services, such as those provided by the service layer (913), provide reusable, defined business functionalities through a defined interface. For example, the interface may be software written in JAVA, C++, or other suitable language providing data in extensible markup language (XML) format or other suitable format. While illustrated as an integrated component of the computer (902), alternative implementations may illustrate the API (912) or the service layer (913) as stand-alone components in relation to other components of the computer (902) or other components (whether or not illustrated) that are coupled to the computer (902). Moreover, any or all parts of the API (912) or the service layer (913) may be implemented as child or sub-modules of another software module, enterprise application, or hardware module without departing from the scope of this disclosure.

The computer (902) includes an interface (904). Although illustrated as a single interface (904) in FIG. 9, two or more interfaces (904) may be used according to particular needs, desires, or particular implementations of the computer (902). The interface (904) is used by the computer (902) for communicating with other systems in a distributed environment that are connected to the network (930). Generally, the interface (904 includes logic encoded in software or hardware (or a combination of software and hardware) and operable to communicate with the network (930) or cloud. More specifically, the interface (904) may include software supporting one or more communication protocols associated with communications such that the network (930) or interface's hardware is operable to communicate physical signals within and outside of the illustrated computer (902).

The computer (902) includes at least one computer processor (905). Although illustrated as a single computer processor (905) in FIG. 9, two or more processors may be used according to particular needs, desires, or particular implementations of the computer (902). Generally, the computer processor (905) executes instructions and manipulates data to perform the operations of the computer (902) and any algorithms, methods, functions, processes, flows, and procedures as described in the instant disclosure.

The computer (902) also includes a memory (906) that holds data for the computer (902) or other components (or a combination of both) that can be connected to the network (930). For example, memory (906) can be a database storing data consistent with this disclosure. Although illustrated as a single memory (906) in FIG. 9, two or more memories may be used according to particular needs, desires, or particular implementations of the computer (902) and the described functionality. While memory (906) is illustrated as an integral component of the computer (902), in alternative implementations, memory (906) can be external to the computer (902).

The application (907) is an algorithmic software engine providing functionality according to particular needs, desires, or particular implementations of the computer (902), particularly with respect to functionality described in this disclosure. For example, application (907) can serve as one or more components, modules, applications, etc. Further, although illustrated as a single application (907), the application (907) may be implemented as multiple applications (907) on the computer (902). In addition, although illustrated as integral to the computer (902), in alternative implementations, the application (907) can be external to the computer (902).

There may be any number of computers (902) associated with, or external to, a computer system containing computer (902), each computer (902) communicating over network (930). Further, the term “client,” “user,” and other appropriate terminology may be used interchangeably as appropriate without departing from the scope of this disclosure. Moreover, this disclosure contemplates that many users may use one computer (902), or that one user may use multiple computers (902).

In some embodiments, the computer (902) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, a cloud computing system may operate according to one or more service models, such as infrastructure as a service (IaaS), platform as a service (PaaS), software as a service (SaaS), mobile “backend” as a service (MBaaS), artificial intelligence as a service (AIaaS), serverless computing, and/or function as a service (FaaS).

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A method, comprising:
obtaining seismic data regarding a geological region of interest;
determining, by a plurality of parallel processing nodes, a plurality of interpolation windows;
determining, by the plurality of parallel processing nodes, a plurality of window seismic datasets based on the seismic data and the plurality of interpolation windows;
generating, by the plurality of parallel processing nodes, a plurality of interpolated window datasets for the plurality of interpolation windows using a Fourier transform and the plurality of window seismic datasets,
wherein a respective interpolated window dataset among the plurality of interpolated window datasets is generated by a respective parallel processing node among the plurality of parallel processing nodes; and
generating, by the plurality of parallel processing nodes, interpolated seismic data for the geological region of interest using the plurality of interpolated window datasets.

2. The method of claim 1, further comprising:
generating a seismic image of the geological region of interest based on the interpolated seismic data.

3. The method of claim 1,
wherein the plurality of parallel processing nodes comprise a master processor and a plurality of slave processors.

4. The method of claim 1,
wherein the plurality of interpolation windows comprise a first interpolation window and a second interpolation window, the first interpolation window comprising a first overlapping zone,
wherein the first overlapping zone comprises a plurality of seismic traces that are disposed in the first interpolation window and the second interpolation window,
wherein the plurality of seismic traces are used to generate a first plurality of interpolated seismic traces that are located in the first overlapping zone, and
wherein the first plurality of interpolated seismic traces in the first overlapping zone are merged with a second plurality of interpolated seismic traces from a second overlapping zone in the second interpolation window to produce a portion of the interpolated seismic data.

5. The method of claim 1,
wherein the seismic data corresponds to one or more seismic surveys with a plurality of seismic sources at a first plurality of source locations and a plurality of seismic receivers at a first plurality of receiver locations,
wherein the interpolated seismic data corresponds to a second plurality of source locations that are greater than the first plurality of source locations, and
wherein the interpolated seismic data corresponds to a second plurality of receiver locations that are greater than the first plurality of receiver locations.

6. The method of claim 1,
wherein the seismic data corresponds to a plurality of acquired seismic traces from a first plurality of seismic receivers with an irregular sampling based on different elevations and different distances between adjacent seismic receivers among the first plurality of seismic receivers, and
wherein the interpolated seismic data corresponds to a plurality of regularized seismic traces with a regular sampling based on a second plurality of seismic receivers disposed at a plurality of receiver locations according to a predetermined periodic interval.

7. The method of claim 1, further comprising:
transmitting the seismic data to the plurality of parallel processing nodes;
determining a first interpolation task for a first parallel processing node and a second interpolation task for a second parallel processing node among the plurality of parallel processing nodes;
determining, by the first parallel processing node, a first portion of the seismic data based on the first interpolation task; and
determining, by the second parallel processing node, a second portion of the seismic data based on the second interpolation task,
wherein the first portion of the seismic data is different from the second portion of the seismic data,
wherein the first portion of the seismic data is used by the first parallel processing node to generate a first interpolation window dataset, and
wherein the second portion of the seismic data is used by the second parallel processing node to generate a second interpolation window dataset.

8. The method of claim 1, further comprising:
determining, by the plurality of parallel processing nodes, a plurality of spatial boundaries for the plurality of interpolation windows using a plurality of trace headers from the seismic data;
determining, by the respective parallel processing node, a plurality of seismic traces for a respective interpolation window among the plurality of interpolation windows using one or more spatial boundaries among the plurality of spatial boundaries; and
generating, by the respective parallel processing node, a plurality of interpolated seismic traces for the respective interpolation window.

9. The method of claim 1,
wherein a respective interpolation window among the plurality of interpolation windows corresponds to at least one spatial boundary that separates a portion of the seismic data that is used by the respective interpolation window for interpolation from a remaining portion of the seismic data that is not used by the respective interpolation window.

10. The method of claim 1,
wherein the plurality of parallel processing nodes communicate using a message passing interface (MPI) protocol.

11. The method of claim 1,
wherein the respective parallel processing node among the plurality of parallel processing nodes is disposed in a graphical processing unit (GPU).

12. The method of claim 1, further comprising:
determining, by a first parallel processing node among the plurality of parallel processing nodes, a first compressed window dataset using a first interpolated window dataset and a compression function; and
determining, by a second parallel processing node among the plurality of parallel processing nodes, a second compressed window dataset using a second interpolated window dataset and the compression function,
wherein the interpolated seismic data comprises decompressed merged data that is based on the first compressed window dataset and the second compressed window dataset.

13. The method of claim 1,
wherein the interpolated seismic data is generated using a first compressed window dataset, a second compressed window dataset, and a decompression function.

14. The method of claim 1, further comprising:
determining a presence of hydrocarbon deposits in the geological region of interest using a seismic image based on the interpolated seismic data.

15. The method of claim 1, further comprising:
acquiring, using a seismic surveying system, the seismic data regarding the geological region of interest.

16. A system, comprising:
a plurality of parallel processing nodes,
wherein the plurality of parallel processing nodes are configured to:
determine a plurality of interpolation windows,
determine a plurality of window seismic datasets based on seismic data for a geological region of interest and the plurality of interpolation windows,
generate a plurality of interpolated window datasets for the plurality of interpolation windows using a Fourier transform and the plurality of window seismic datasets,
wherein a respective interpolated window dataset among the plurality of interpolated window datasets is generated by a respective parallel processing node among the plurality of parallel processing nodes,
generate interpolated seismic data for the geological region of interest using the plurality of interpolated window datasets.

17. The system of claim 16, further comprising:
a seismic interpreter coupled to the plurality of parallel processing nodes, the seismic interpreter comprising a computer processor,
wherein the seismic interpreter is configured to generate a seismic image of the geological region of interest based on the interpolated seismic data.

18. The system of claim 16,
wherein the plurality of interpolation windows comprise a first interpolation window and a second interpolation window, the first interpolation window comprising a first overlapping zone,
wherein the first overlapping zone comprises a plurality of seismic traces that are disposed in the first interpolation window and the second interpolation window,
wherein the plurality of seismic traces are used to generate a first plurality of interpolated seismic traces that are located in the first overlapping zone, and
wherein the first plurality of interpolated seismic traces in the first overlapping zone are merged with a second plurality of interpolated seismic traces from a second overlapping zone in the second interpolation window to produce a portion of the interpolated seismic data.

19. The system of claim 16,
wherein the plurality of parallel processing nodes comprises a first parallel processing node and a second parallel processing node,
wherein the first parallel processing node is configured to determine a first compressed window dataset using a first interpolated window dataset and a compression function,
wherein the second parallel processing node is configured to determine a second compressed window dataset using a second interpolated window dataset and the compression function, and
wherein the interpolated seismic data comprise decompressed merged data that is based on the first compressed window dataset and the second compressed window dataset.

20. The system of claim 16, further comprising:
a seismic surveying system configured to acquire the seismic data.
